(19) United States
(12) Patent Application Publication
(10) Pub. No.: US 2026/0266621 A1
(43) Pub. Date: Sep. 10, 2026

(54) SYSTEM AND METHOD FOR RECOMMENDING CHARGING STATION

(71) Applicant: American Honda Motor Co., Inc.,, Torrance, CA (US)

(72) Inventors: David Wong Cun, Fountain Valley, CA (US); Manzhen Jing, Torrance, CA (US)

(21) Appl. No.: 19/075,231

(22) Filed: Mar. 10, 2025

(51) Int. Cl. G01C 21/36; B60L 53/66; G01C 21/34

(52) U.S. Cl. CPC G01C 21/3679; B60L 53/66; G01C 21/3469; G01C 21/3617; B60L 2240/60

(57) ABSTRACT

A system for recommending a charging station to a user of an electric vehicle includes at least one processor configured to receive at least one parameter associated with the user of the electric vehicle. The processor is further configured to provide the at least one parameter to a plurality of candidate charging stations. The processor is further configured to receive a plurality of bid amounts from the plurality of candidate charging stations. Each bid amount of the plurality of bid amounts is indicative of a preference of a corresponding candidate charging station with respect to the at least one parameter. The processor is further configured to determine at least one proposed charging station from the plurality of candidate charging stations based on the plurality of bid amounts. The processor is further configured to present the at least one proposed charging station to the user of the electric vehicle.

### BACKGROUND

The disclosed subject matter relates to a system and a method for recommending a charging station to a user of an electric vehicle.

Electric vehicles use electrical energy provided by batteries as a power source for mobility. Specifically, batteries supply the electrical energy to an electric motor, allowing the electric motor to move the electric vehicle. However, since the batteries get discharged after the electric vehicle has driven a certain distance, they must be recharged. In certain cases, batteries of the electric vehicle may be recharged using a charger at charging stations. Such charging stations may be located in, e.g., a highway rest area, a large supermarket, a government office, a public parking lot, etc. Charging stations are often treated as points of interest (POI), which are searched by navigation systems and recommended to electric vehicles. Existing charging station recommendation systems primarily suggest charging stations to users of electric vehicles based on proximity and availability only.

### SUMMARY

In accordance with one embodiment of the present disclosure, a system for recommending a charging station to a user of an electric vehicle. The system includes at least one non-transitory computer-readable storage medium having instructions stored thereon. The system further includes at least one processor coupled to the at least one non-transitory computer-readable storage medium. The processor is configured to execute the instructions to receive at least one parameter associated with the user of the electric vehicle. The processor is further configured to provide the at least one parameter to a plurality of candidate charging stations. The processor is further configured to receive a plurality of bid amounts from the plurality of candidate charging stations. Each bid amount of the plurality of bid amounts is indicative of a preference of a corresponding candidate charging station of the plurality of candidate charging stations with respect to the at least one parameter. The processor is further configured to determine at least one proposed charging station from the plurality of candidate charging stations based on the plurality of bid amounts. The processor is further configured to present the at least one proposed charging station to the user of the electric vehicle.

In accordance with another embodiment of the present disclosure, a method for recommending a charging station to a user of an electric vehicle. The method includes receiving at least one parameter associated with the user of the electric vehicle. The method further includes providing the at least one parameter to a plurality of candidate charging stations. The method further includes receiving a plurality of bid amounts from the plurality of candidate charging stations. Each bid amount of the plurality of bid amounts is indicative of a preference of a corresponding candidate charging station of the plurality of candidate charging stations with respect to the at least one parameter. The method further includes determining at least one proposed charging station from the plurality of candidate charging stations based on the plurality of bid amounts. The method further includes presenting the at least one proposed charging station to the user of the electric vehicle.

In accordance with yet another embodiment of the present disclosure, a method for recommending a charging station to a user of an electric vehicle. The method includes receiving a request for providing at least one recommended charging station from the user of the electric vehicle. The method further includes receiving at least one parameter associated with the user of the electric vehicle. The method further includes providing the at least one parameter to a plurality of candidate charging stations. The method further includes receiving a plurality of bid amounts from the plurality of candidate charging stations. Each bid amount of the plurality of bid amounts is indicative of a preference of a corresponding candidate charging station of the plurality of candidate charging stations with respect to the at least one parameter. The method further includes determining at least one proposed charging station from the plurality of candidate charging stations based on the plurality of bid amounts. The at least one proposed charging station has the highest bid amount. The method further includes transmitting the at least one proposed charging station to the electric vehicle. The method further includes displaying, via an output device, the at least one proposed charging station to the user of the electric vehicle.

### BRIEF DESCRIPTION OF THE DRAWINGS

Certain embodiments of the present disclosure will be better understood from the following description taken in conjunction with the accompanying drawings in which:

FIG. 1 is a block diagram showing a system for recommending a charging station to a user of an electric vehicle in accordance with an embodiment of the present disclosure;

FIG. 2 is a flowchart depicting various steps of a method for recommending a charging station to a user of an electric vehicle in accordance with an embodiment of the present disclosure; and

FIG. 3 is a flowchart depicting various steps of a method for recommending a charging station to a user of an electric vehicle in accordance with another embodiment of the present disclosure.

### DETAILED DESCRIPTION OF EXEMPLARY EMBODIMENTS

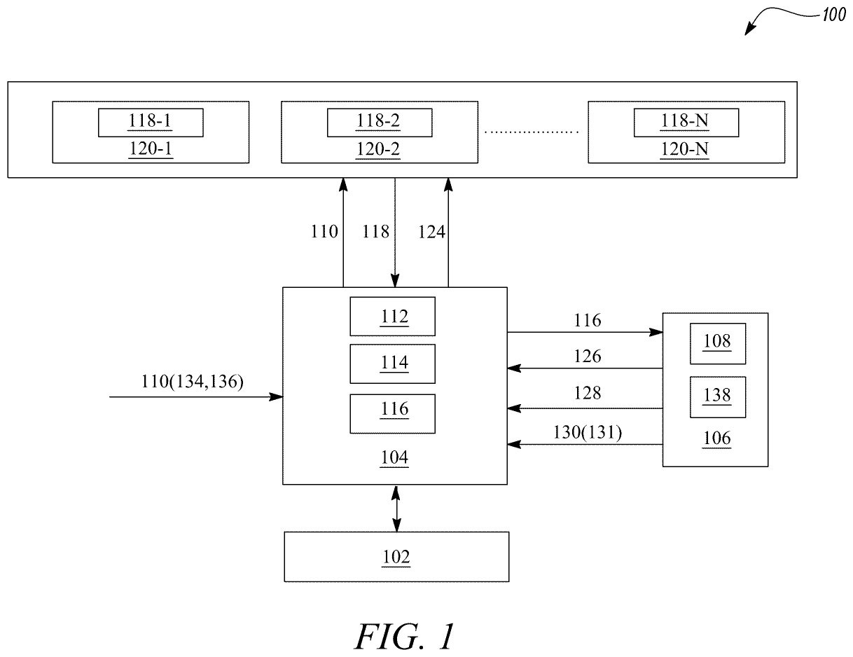

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

The following includes definitions of selected terms employed herein. The definitions include various examples and/or forms of components that fall within the scope of a term and that can be used for implementation. The examples are not intended to be limiting.

As used herein, “a,” “an,” “the,” “at least one,” and “one or more” are used interchangeably.

As used herein, the term “configured to” is at least as restrictive as the term “adapted to” and requires actual design intention to perform the specified function rather than mere physical capability of performing such a function.

As used herein, “at least one of A and B” should be understood to mean “only A, only B, or both A and B.”

As used herein, the term “vehicle” refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle may include one or more engines. Further, the term “vehicle” also refers to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” also refers to an autonomous vehicle and/or self-driving vehicle powered by any form of energy. The autonomous vehicle may or may not carry one or more human occupants. Further, the term “vehicle” refers to vehicles that are automated or non-automated with pre-determined paths or free-moving vehicles.

As used herein, the term “processor” refers generally to any processor that processes signals and performs general computing and arithmetic functions. Signals processed by the processor can include digital signals, data signals, computer instructions, processor instructions, messages, a bit, a bit stream, or other means that can be received, transmitted, and/or detected. Generally, the processor can be a variety of different processor architectures. The term “processor” is intended to encompass central processing units, microprocessors, microcontrollers, reduced instruction set circuits (RISC), application specific integrated circuits (ASIC), logic circuits, and any other circuit or processor capable of executing the functions described herein.

As used herein, the term “computer-readable storage medium” may describe any form of memory or computer-readable storage device. As used herein, the term “memory” refers to volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory may store instructions that are executable by a processor, an operating system, and other data or information.

As used herein, the term “output device” generally refers to any device that outputs information or content. An output device may communicate with and/or be part of another device (e.g., an infotainment device). Some examples of output devices include, but are not limited to, screen displays, heads-up displays, projectors, audio speakers (or other sound or noise-producing devices, such as horns), lights (e.g., ambience lighting, headlights, taillights, fog lamps, etc.), vibration or haptic devices (e.g., vehicle seat massage systems, vehicle suspensions), olfactory devices (e.g., fragrance dispensers), etc.

Referring now to the figures, FIG. 1 illustrates a block diagram of a system 100 for recommending a charging station to a user 108 of an electric vehicle 106 in accordance with an embodiment of the present disclosure. In some embodiments, the electric vehicle 106 may have a rechargeable battery or a power source (not shown) that can be recharged using a wired connection to a power supply, e.g., by plugging into a vehicle charging station or a power socket to access a power supply. Alternatively, the electric vehicle 106 may be recharged wirelessly, e.g., through inductive coupling, where inductive fields utilized for recharging may be generated using power from a power source.

It will be appreciated that the electric vehicle 106 may be an electric-only vehicle or a hybrid vehicle that may operate using electricity or another power/fuel source, such as gasoline, natural gas, other petroleum products, fuel cells, or the like. Many variations of electric vehicles may be utilized in accordance with example embodiments of the present disclosure.

The system 100 includes at least one non-transitory computer-readable storage medium 102 having instructions stored thereon. The system 100 further includes at least one processor 104 coupled to the at least one non-transitory computer-readable storage medium 102. The term “at least one non-transitory computer-readable storage medium 102” is interchangeably referred to herein as “the storage medium 102”. The term “at least one processor 104” is interchangeably referred to herein as “the processor 104”. In some embodiments, the processor 104 may be external to the electric vehicle 106 and may be connected to vehicle systems, sub-systems, hardware components, as well as software applications, and systems that are integrated into the electric vehicle 106.

In some embodiments, the storage medium 102 may include any type of computer readable storage media, including, but not be limited to, various types of volatile and non-volatile storage media, including, but not limited to, random access memory, read-only memory, programmable read-only memory, electrically programmable read-only memory, electrically erasable read-only memory, flash memory, magnetic tape or disk, optical media, and the like. In some cases, the storage medium 102 may include a cache or a random-access memory for the processor 104. Alternatively, or in addition, the storage medium 102 and the processor 104 may be embedded within one unit. In some embodiments, the storage medium 102 may be an external storage device or a database for storing data.

In some embodiments, the processor 104 may be embodied in a number of different ways. For example, the processor 104 may be embodied as various processing means, such as one or more of a microprocessor or other processing elements, a coprocessor, or various other computing or processing devices, including integrated circuits, such as, e.g., an ASIC (application specific integrated circuit), an FPGA (field programmable gate array), or the like.

As such, whether configured by hardware or by a combination of hardware and software, the processor 104 may represent an entity (e.g., physically embodied in circuitry-in the form of processing circuitry) capable of performing operations according to some embodiments while configured accordingly. Thus, for example, when the processor 104 is embodied as an executor of software instructions, the instructions may specifically configure the processor 104 to perform the operations described herein. Alternatively, as another example, when the processor 104 is embodied as an ASIC, FPGA, or the like, the processor 104 may have specifically configured hardware for conducting the operations described herein.

In some embodiments, the system 100 may be implemented as a server-side application, a client-side application, or a hybrid server-side/client-side application, and may be connected to a network (e.g., the Internet or a local area network). In some embodiments, the system 100 may include various components, examples of which may include, but are not limited to, a personal computer, a server computer, a series of server computers, a mini computer, a mainframe computer, one or more Network Attached Storage (NAS) systems, one or more Storage Area Network (SAN) systems, one or more Platform as a Service (PaaS) systems, one or more Infrastructure as a Service (IaaS) systems, one or more Software as a Service (Saas) systems, a cloud-based computational system, and a cloud-based storage platform.

In some embodiments, the processor 104 may be communicatively coupled to the electric vehicle 106 and the storage medium 102 by way of one or more wired and/or wireless communication interfaces. In some examples, the wireless communication interface may communicate data via one or more wireless communication protocols, such as, Bluetooth®, infrared, Wi-Fi, Zigbee, wireless universal serial bus (USB), radio frequency, near-field communication (NFC), RFID protocols, IEEE 802.11a, 802.11b, 802.11g, 802.11n, or generally any wireless communication protocol.

In some embodiments, the processor 104 may communicate with the electric vehicle 106 through a communication network. In some examples, the communication network may include a circuit-switched voice network, a packet-switched data network, or any other network capable of carrying electronic communication. In some examples, the communication network may include one or more of a wireless network, a wired network, a local area network (LAN), a metropolitan area network (MAN), a wide area network (WAN), a wireless personal area network (WPAN), a mobile network, a Virtual Private Network (VPN), public switched telephone network (PSTN), 802.11, 802.16, 802.20, WiMax networks, and/or the like, and may include a set of interconnected networks that make up the Internet.

In some embodiments, the wireless network may include, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc.

The processor 104 is configured to execute the instructions to receive at least one parameter 110 associated with the user 108 of the electric vehicle 106. In some embodiments, the at least one parameter 110 may include personal characteristics of the user 108 of the electric vehicle 106, e.g., age, sex, geographic location, a type of the electric vehicle 106, a manufacturer of the electric vehicle 106, etc. In some embodiments, the at least one parameter 110 includes a personal preference 134 of the user 108 of the electric vehicle 106. The personal preference 134 may include, e.g., eating, driving, hobby, location, social media, parking, charging, internet, vehicle, gas, product, and/or product type preferences of the user 108. As one example, the personal preference 134 of the user 108 may indicate that the user 108 prefers to visit a bakery shop frequently.

In some embodiments, the personal preference 134 of the user 108 may be determined based on the following embodiments of data of the user 108: mobile device (or smartphone) application data, data shared with the electric vehicle 106, vehicle driving data, voice data, motion data, emotion data, spending/credit card/debit card data, errand data, travel data, location data, etc. The foregoing list is non-exhaustive, as any other user data types are also applicable for determining user preferences.

User data may be collected from various sources and shared with the electric vehicle 106. Such sources may include in-vehicle sensors (including steering sensors, environment sensors, seat sensors, instrument panel sensors), cameras, or other imaging sensors, microphones, gyroscopes, accelerometers, smoke detectors, gas sensors, or other air-quality/particle sensors, temperature sensors, humidity sensors, motion sensors, door sensors, electromagnetic detectors, ultrasonic detectors, optical detectors, physiological sensors, smart glasses (eye-glasses or sun-glasses), health and wellness sensors, navigation instruments/devices, sensors mounted on smartphones, data collected by smartphones/smart watches, among others.

In some embodiments, the at least one parameter 110 includes a preferred action 136 of the user 108 of the electric vehicle 106. The preferred action 136 may include, e.g., a dwelling time of the electric vehicle 106, frequent visited locations of the electric vehicle 106, a charging or parking activity of the electric vehicle 106, etc. For example, the preferred action 136 of the user 108 may indicate that the user 108 prefers to park and charge in or near a park or a shopping mall.

In some embodiments, the at least one parameter 110 may be associated with daily activities of the user 108 of the electric vehicle 106. In some embodiments, the system 100 may capture charging activity and dwelling activity of the electric vehicle 106 over time, e.g., through a telematics unit (not shown) located on the electric vehicle 106. In some embodiments, the telematics unit may capture and store data, such as a battery state of charge, charging activity, parking activity, etc. in a memory.

Alternatively, the system 100 may obtain such data from other sources, e.g., charging station network, credit card companies, etc. For example, charging station network aggregators may capture information associated with the user 108, such as charging activities from charging stations, smartphone activity, behavioral data, personal data, transactional information, etc. The user 108 may authorize the system 100 or the other sources to capture such information. In some embodiments, the at least one parameter 110 may be stored on a remote server, or in a computer associated with the electric vehicle 106, and accessible to the processor 104. In some embodiments, the processor 104 may implement artificial intelligence or machine learning techniques to learn behavior of the user 108 over time.

The processor 104 is further configured to provide the at least one parameter 110 to a plurality of candidate charging stations 120-1, 120-2, . . . , 120-N (collectively referred to herein as candidate charging stations 120), where N is natural number corresponding to a total number of the candidate charging stations 120 in the plurality of candidate charging stations 120 (e.g., N=2, 5, etc.). In some embodiments, the processor 104 may provide the at least one parameter 110 to the plurality of candidate charging stations 120 after a predetermined period of time, e.g., weekly, monthly, quarterly, etc.

The processor 104 is further configured to receive a plurality of bid amounts 118-1, 118-2, . . . , 118-N (collectively referred to herein as bid amounts 118) from the plurality of candidate charging stations 120. For example, the bid amount 118-1 is received from the charging station 120-1, the bid amount 118-2 is received from the charging station 120-2, and so on. Each bid amount 118 of the plurality of bid amounts 118 is indicative of a preference of a corresponding candidate charging station 120 of the plurality of candidate charging stations 120 with respect to the at least one parameter 110. For example, upon receiving the at least one parameter 110, each candidate charging station 120 may determine the corresponding bid amount 118 based on the at least one parameter 110.

Each candidate charging station 120 may place the corresponding bid amount 118 representing their preference to be recommended to the user 108 of the electric vehicle 106. For example, one or more candidate charging stations 120 may place a higher respective bid amounts 118 for the at least one parameter 110 that indicates that the user 108 likes to do shopping frequently in case the one or more candidate charging stations 120 may have a shopping mall nearby. In some cases, such candidate charging stations 120 may have an agreement with the nearby shopping mall to draw more customers.

Moreover, the system 100 may present an opportunity to the one or more candidate charging stations 120 to get recommended where the user 108 otherwise may not have visited due to inconvenience or other reasons. For example, the system 100 may present an opportunity to the one or more candidate charging stations 120 that are located on alternative routes to a destination of the user 108.

In some embodiments, the processor 104 is further configured to receive a request 130 for providing at least one recommended charging station 131 from the user 108 of the electric vehicle 106. For example, when the user 108 of the electric vehicle 106 searches for charging stations along a pathway to a destination for recharging the batteries via the telematic units, the processor 104 may provide the at least one parameter 110 to the plurality of candidate charging stations 120. Subsequently, the processor 104 may receive the plurality of bid amounts 118 from the plurality of candidate charging stations 120. In such cases, the processor 104 may receive the plurality of bid amounts 118 from the plurality of candidate charging stations 120 in real time.

Alternatively, the processor 104 is further configured to receive and/or determine a charging intent 126 of the electric vehicle 106 for receiving the plurality of bid amounts 118 from the plurality of candidate charging stations 120. For example, the processor 104 may receive the plurality of bid amounts 118 when the electric vehicle 106 is running low on battery as determined by a state of charge (SOC) of the battery, or a remaining drive time of the electric vehicle 106, and a current location of the electric vehicle 106, etc.

In some embodiments, the processor 104 is further configured to periodically receive the plurality of bid amounts 118 from the plurality of candidate charging stations 120 after a predetermined period of time 112, e.g., weekly, monthly, quarterly, etc. In such cases, the plurality of candidate charging stations 120 may provide the plurality of bid amounts 118 intermittently after the predetermined period of time 112 instead of in real time.

The processor 104 is further configured to determine at least one proposed charging station 116 from the plurality of candidate charging stations 120 based on the plurality of bid amounts 118. Specifically, the processor 104 is further configured to determine the at least one proposed charging station 116 based on the candidate charging station 120 having the highest bid amount 114. For example, the processor 104 may select the candidate charging stations 120 having the highest bid amount 114 as the at least one proposed charging station 116. In some cases, multiple candidate charging stations 120 may be selected if some of the corresponding bid amounts 118 are the same. In some embodiments, the at least one proposed charging station 116 may include multiple proposed charging stations 116. Alternatively, in an embodiment, no candidate charging station 120 may be selected if none of the corresponding bid amounts 118 surpass a predetermined threshold.

In some embodiments, the at least one proposed charging station 116 having the highest bid amount 114 may be automatically selected/determined by the processor 104. Alternatively, the user 108 may select their own charging stations from the plurality of candidate charging stations 120 provided to them. In such cases, top recommendations (or the proposed charging stations 116) may be listed first, or the top recommendations may be visually highlighted and differentiated from the other recommendations, or the top recommendations may be sorted in an order based on the corresponding bid amounts 118.

In some embodiments, the processor 104 is further configured to receive an input 128 from the user 108 of electric vehicle 106 indicative of an approval for receiving the at least one proposed charging station 116. Thus, the user 108 of electric vehicle 106 may have an option to choose to receive the at least one proposed charging station 116 from the system 100, which may also recommend the candidate charging stations 120 that are not directly preferred by the user 108 of the electric vehicle 106, or that may be located on alternative pathways, or that may not usually get recommended to the user 108.

The processor 104 is further configured to present the at least one proposed charging station 116 to the user 108 of the electric vehicle 106. For example, the processor 104 may display the at least one proposed charging station 116 on an output device 138 (e.g., a digital instrument cluster and/or an infotainment system) of the electric vehicle 106. In some embodiments, the output device 138 may include the telematics unit and/or a smartphone or a mobile device of the user 108 of the electric vehicle 106.

In some embodiments, the processor 104 may determine the at least one proposed charging station 116 when required. For example, the processor 104 is further configured to receive the request 130 for providing the at least one recommended charging station 131 from the user 108 of the electric vehicle 106 prior to presenting the at least one proposed charging station 116. Alternatively, the processor 104 is further configured to determine the charging intent 126 of the electric vehicle 106 prior to presenting the at least one proposed charging station 116 to the user 108 of the electric vehicle 106.

In some embodiments, the processor 104 is further configured to deliver a notification 124 to the candidate charging station 120 if the corresponding bid amount 118 is accepted as the highest bid amount 114. In other words, the candidate charging station 120 may receive the notification from the processor 104 when the corresponding bid amount 118 is the highest bid amount 114.

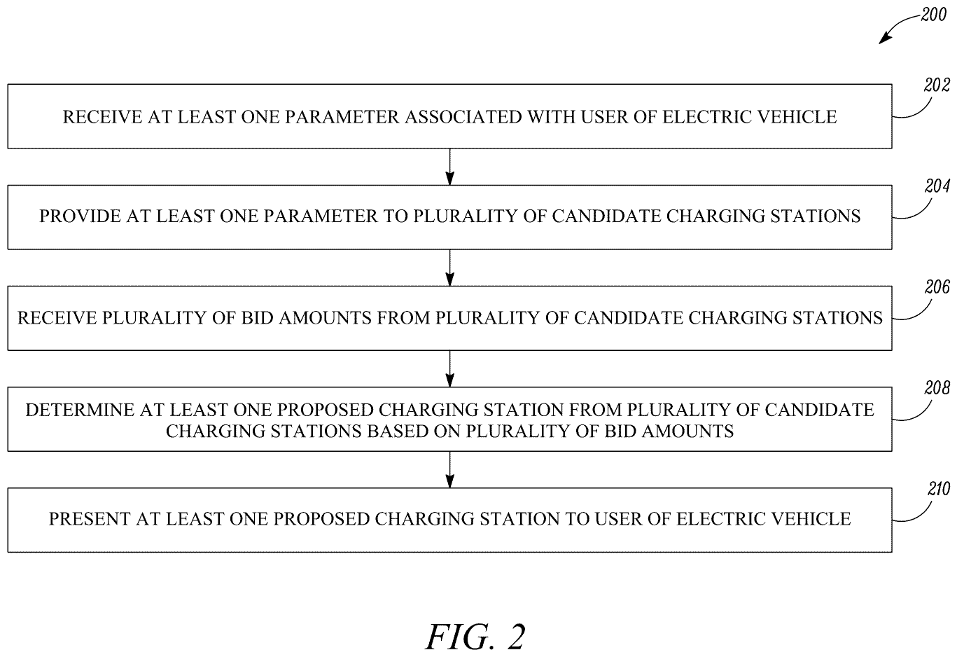

FIG. 2 illustrates a flowchart depicting various steps of a method 200 for recommending a charging station to a user (e.g., the user 108 shown in FIG. 1) of an electric vehicle (e.g., the electric vehicle 106 shown in FIG. 1) in accordance with an embodiment of the present disclosure. The method 200 may be carried out, for example, by the system 100 of FIG. 1. The method 200 will be discussed with further reference to FIG. 1.

Referring to FIGS. 1 and 2, at step 202, the method 200 includes receiving the at least one parameter 110 associated with the user 108 of the electric vehicle 106. In some embodiments, the at least one parameter 110 includes the personal preference 134 of the user 108 of the electric vehicle 106. In some embodiments, the at least one parameter 110 includes the preferred action 136 of the user 108 of the electric vehicle 106.

At step 204, the method 200 further includes providing the at least one parameter 110 to the plurality of candidate charging stations 120.

At step 206, the method 200 further includes receiving the plurality of bid amounts 118 from the plurality of candidate charging stations 120. Each bid amount 118 of the plurality of bid amounts 118 is indicative of the preference of the corresponding candidate charging station 120 of the plurality of candidate charging stations 120 with respect to the at least one parameter 110. The method 200 further includes periodically receiving the plurality of bid amounts 118 from the plurality of candidate charging stations 120 after the predetermined period of time 112.

At step 208, the method 200 further includes determining the at least one proposed charging station 116 from the plurality of candidate charging stations 120 based on the plurality of bid amounts 118. In some embodiments, determining the at least one proposed charging station 116 includes determining the candidate charging station 120 having the highest bid amount 114.

At step 210, the method 200 further includes presenting the at least one proposed charging station 116 to the user 108 of the electric vehicle 106. In some embodiments, the method 200 further includes receiving the input 128 from the user 108 of electric vehicle 106 indicative of an approval for receiving the at least one proposed charging station 116.

In some embodiments, the method 200 further includes determining the charging intent 126 of the electric vehicle 106 prior to presenting the at least one proposed charging station 116 to the user 108 of the electric vehicle 106. In some embodiments, the method 200 further includes receiving the request 130 for providing at least one recommended charging station 131 from the user 108 of the electric vehicle 106 prior to presenting the at least one proposed charging station 116.

In some embodiments, the method 200 further includes delivering the notification 124 to the candidate charging station 120 if the corresponding bid amount 118 is accepted as the highest bid amount 114.

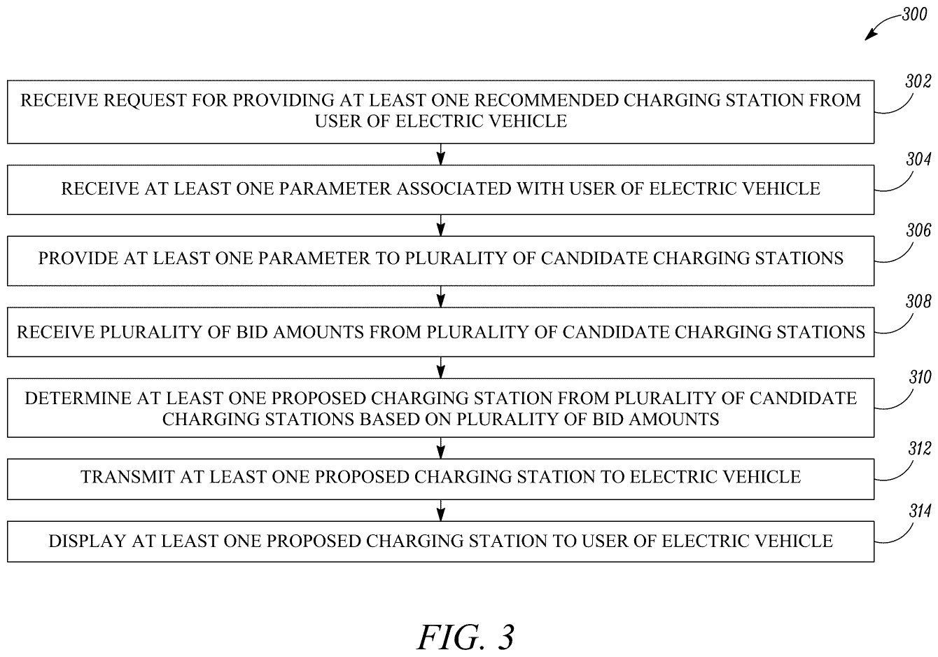

FIG. 3 illustrates a flowchart depicting various steps of a method 300 for recommending a charging station to a user (e.g., the user 108 shown in FIG. 1) of an electric vehicle (e.g., the electric vehicle 106 shown in FIG. 1) in accordance with an embodiment of the present disclosure. The method 300 may be carried out, for example, by the system 100 of FIG. 1. The method 300 will be discussed with further reference to FIG. 1.

Referring to FIGS. 1 and 2, at step 302, the method 300 includes receiving the request 130 for providing the at least one recommended charging station 131 from the user 108 of the electric vehicle 106.

At step 304, the method 300 further includes receiving the at least one parameter 110 associated with the user 108 of the electric vehicle 106.

At step 306, the method 300 further includes providing the at least one parameter 110 to the plurality of candidate charging stations 120.

At step 308, the method 300 further includes receiving the plurality of bid amounts 118 from the plurality of candidate charging stations 120. Each bid amount 118 of the plurality of bid amounts 118 is indicative of a preference of the corresponding candidate charging station 120 of the plurality of candidate charging stations 120 with respect to the at least one parameter 110.

At step 310, the method 300 further includes determining the at least one proposed charging station 116 from the plurality of candidate charging stations 120 based on the plurality of bid amounts 118. The at least one proposed charging station 116 has the highest bid amount 114. In some embodiments, the method 300 further includes receiving the input 128 from the user 108 of electric vehicle 106 indicative of an approval for receiving the at least one proposed charging station 116.

At step 312, the method 300 further includes transmitting the at least one proposed charging station 116 to the electric vehicle 106.

At step 314, the method 300 further includes displaying, via the output device 138, the at least one proposed charging station 116 to the user 108 of the electric vehicle 106.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

1. A system for recommending a charging station to a user of an electric vehicle, the system comprising:
at least one non-transitory computer-readable storage medium having instructions stored thereon; and
at least one processor coupled to the at least one non-transitory computer-readable storage medium and configured to execute the instructions to:
receive at least one parameter associated with the user of the electric vehicle;
provide the at least one parameter to a plurality of candidate charging stations, wherein each of the plurality of candidate charging stations is configured to generate the corresponding bid amount in response to receipt of the at least one parameter;
receive a plurality of bid amounts from the plurality of candidate charging stations, wherein each bid amount of the plurality of bid amounts is indicative of a preference of a corresponding candidate charging station of the plurality of candidate charging stations with respect to the at least one parameter; and
determine at least one proposed charging station from the plurality of candidate charging stations based on the plurality of bid amounts;
an output device communicably coupled to the at least one processor, the output device configured to display the at least one proposed charging station based on the plurality of bid amounts received from the plurality of candidate charging stations in response to the at least one parameter.

2. The system of claim 1, wherein the at least one parameter comprises a personal preference of the user of the electric vehicle.

3. The system of claim 1, wherein the at least one parameter comprises a preferred action of the user of the electric vehicle.

4. The system of claim 1, wherein the processor is further configured to determine a charging intent of the electric vehicle prior to presenting the at least one proposed charging station to the user of the electric vehicle.

5. The system of claim 1, wherein the processor is further configured to receive a request for providing at least one recommended charging station from the user of the electric vehicle prior to presenting the at least one proposed charging station.

6. The system of claim 1, wherein the processor is further configured to determine the at least one proposed charging station based on the candidate charging station having a highest bid amount among the plurality of bid amounts received from the plurality of candidate charging stations.

7. The system of claim 1, wherein the processor is further configured to receive an input from the user of electric vehicle indicative of an approval for receiving the at least one proposed charging station.

8. The system of claim 1, wherein the processor is further configured to periodically receive the plurality of bid amounts from the plurality of candidate charging stations after a predetermined period of time.

9. The system of claim 1, wherein the processor is further configured to deliver a notification to the candidate charging station if the corresponding bid amount is accepted as a highest bid amount among the plurality of bid amounts received from the plurality of candidate charging stations.

10. A method for recommending a charging station to a user of an electric vehicle, the method comprising:
receiving, by at least one processor, at least one parameter associated with the user of the electric vehicle, wherein the at least one processor is coupled to at least one non-transitory computer-readable storage medium having instructions stored thereon. and wherein the at least one processor is configured to execute the instructions;
providing, by the at least one processor, the at least one parameter to a plurality of candidate charging stations, wherein each of the plurality of candidate charging stations is configured to generate the corresponding bid amount in response to receipt of the at least one parameter;
receiving, by the at least one processor, a plurality of bid amounts from the plurality of candidate charging stations, wherein each bid amount of the plurality of bid amounts is indicative of a preference of a corresponding candidate charging station of the plurality of candidate charging stations with respect to the at least one parameter;
determining, by the at least one processor, at least one proposed charging station from the plurality of candidate charging stations based on the plurality of bid amounts; and
transmitting, by the at least one processor, the at least one proposed charging station to an output device; and
displaying, by the output device, the at least one proposed charging station wherein the output device is further configured to display the at least one proposed charging station in association with the plurality of bid amounts, wherein the at least one proposed charging station is highlighted relative to other candidate charging stations based on the plurality of bid amounts.

11. The method of claim 10, wherein the at least one parameter comprises a personal preference of the user of the electric vehicle.

12. The method of claim 10, wherein the at least one parameter comprises a preferred action of the user of the electric vehicle.

13. The method of claim 10, further comprising determining a charging intent of the electric vehicle prior to presenting the at least one proposed charging station to the user of the electric vehicle.

14. The method of claim 10, further comprising receiving a request for providing at least one recommended charging station from the user of the electric vehicle prior to presenting the at least one proposed charging station.

15. The method of claim 10, wherein determining the at least one proposed charging station comprises determining the candidate charging station having a highest bid amount among the plurality of bid amounts received from the plurality of candidate charging stations.

16. The method of claim 10, further comprising receiving an input from the user of electric vehicle indicative of an approval for receiving the at least one proposed charging station.

17. The method of claim 10, further comprising periodically receiving the plurality of bid amounts from the plurality of candidate charging stations after a predetermined period of time.

18. The method of claim 10, further comprising delivering a notification to the candidate charging station if the corresponding bid amount is accepted as a highest bid amount among the plurality of bid amounts received from the plurality of candidate charging stations.

19. A method for recommending a charging station to a user of an electric vehicle, the method comprising:
receiving, by at least one processor, a request for providing at least one recommended charging station from the user of the electric vehicle, wherein the at least one processor is coupled to at least one non-transitory computer-readable storage medium having instructions stored thereon, and wherein the at least one processor is configured to execute the instructions;
receiving, by the at least one processor, at least one parameter associated with the user of the electric vehicle;
providing, by the at least one processor, the at least one parameter to a plurality of candidate charging stations, wherein each of the plurality of candidate charging stations is configured to generate the corresponding bid amount in response to receipt of the at least one parameter;
receiving, by the at least one processor, a plurality of bid amounts from the plurality of candidate charging stations, wherein each bid amount of the plurality of bid amounts is indicative of a preference of a corresponding candidate charging station of the plurality of candidate charging stations with respect to the at least one parameter;
determining, by the at least one processor, at least one proposed charging station from the plurality of candidate charging stations based on the plurality of bid amounts, wherein the at least one proposed charging station has a highest bid amount among to the plurality of bid amounts received from the plurality of candidate charging stations;
transmitting, by the at least one processor, the at least one proposed charging station to the electric vehicle using a communication network; and
displaying, via an output device, the at least one proposed charging station to the user of the electric vehicle, wherein the output device is further configured to display the at least one proposed charging station in association with the plurality of bid amounts, wherein the at least one proposed charging station is highlighted relative to other candidate charging stations based on the plurality of bid amounts.

20. The method of claim 19, further comprising receiving an input from the user of electric vehicle indicative of an approval for receiving the at least one proposed charging station.
